(19) United States
(12) Patent Application Publication
(10) Pub. No.: US 2009/0053432 A1
(43) Pub. Date: Feb. 26, 2009

(54) Apparatus for cushioning a child

(76) Inventors: Alyssa Metz-Topodas, Paoli, PA (US); Karen M. Kazmorck, Douglassville, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 12/228,514

(22) Filed: Aug. 13, 2008

Related U.S. Application Data
(60) Provisional application No. 60/964,466, filed on Aug. 13, 2007.

(51) Int. Cl. F16B 5/07

(52) U.S. Cl. 428/33

(57) ABSTRACT

The invention is a mat having a shape wherein the mat comprises a mat body and insert. The mat body and insert are each manufactured from a mat material that may be foam. Preferably, the mat body and insert are separately encased in washable fabric covers optionally fitted with accessory attachment points.

### FIELD OF THE INVENTION

The present invention is directed to an apparatus for cushioning a child. More specifically, it is directed to an apparatus for cushioning a seated child.

### BACKGROUND OF THE INVENTION

It is well appreciated that a baby who is unaccustomed to sitting without support will inevitably fall when placed in a seated position. This propensity to fall requires that a caregiver maintain an obstacle free area around the child. Removing obstacles ensures that when the child falls, he or she does not fall into an object that could cause injury.

Simply clearing and maintaining an obstacle free area though, is typically insufficient. A baby falling onto the floor is equally likely to injure itself when its head or outstretched limb impacts an unforgiving flooring surface. Caregivers typically deal with this issue by stacking pillows around the child to mitigate the possibility of injury. This solution, however, requires the utilization of many pillows, constrains the infant, and is not an easily portable solution. In addition, pillows provide little or no stimulation for a child eager for interaction.

### BRIEF SUMMARY OF THE INVENTION

The present invention may be generally described as a mat having a shape, wherein the mat comprises a mat body and an insert. The mat body includes a well adapted to receive the insert, a top wall and a bottom wall connected through one or more side walls and one or more well walls. In preferred embodiments, the well walls are independently angled relative to the mat body bottom wall. The insert includes a top wall and a bottom wall connected through one or more well contacting walls wherein the well contacting walls are independently angled relative to the insert top wall. The mat body and insert each comprise a mat material. The invention may further comprise one or more fabric covers.

### BRIEF DESCRIPTION OF THE FIGURES

FIG. 1A is a plan view of an exemplary mat body according to the invention.

FIG. 1B is a front view of the mat body.

FIG. 1C is a side view of the mat body.

FIG. 1D is a plan view of an inverted insert, i.e. an insert resting on its top wall such that the bottom wall of the insert is visible when the insert is viewed from above.

FIG. 1E is a front view of the inverted insert.

FIG. 1F is a side view of the inverted insert.

FIG. 2A is a plan view of an exemplary encasement style mat body fabric cover for enclosing the mat body.

FIG. 2B is a front view of the encasement style mat body fabric cover.

FIG. 2C is a side view of the encasement style mat body fabric cover.

FIG. 2D is a plan view of an exemplary encasement style insert fabric cover for encasing the insert.

FIG. 2E is a front view of an encasement style insert fabric cover.

FIG. 2F is a side view of the encasement style insert fabric cover.

FIG. 2G is a rear view of the encasement style mat body fabric cover.

FIG. 3A is a plan view of an embodiment of a mat of the present invention wherein an insert encased in an insert cover is disposed in the well of a mat body encased in a mat body fabric cover.

FIG. 3B is a front view of an embodiment of a mat of the present invention wherein an insert encased in an insert cover is disposed in the well of a mat body encased in a mat body fabric cover.

FIG. 3C is a side view of an embodiment of a mat of the present invention wherein an insert encased in an insert cover is disposed in the well of a mat body encased in a mat body fabric cover.

FIG. 4A is a plan view of an embodiment of a mat of the present invention wherein an insert encased in an insert cover is detachably attached to the top wall of a mat body fabric cover encasing a mat body.

FIG. 4B is a front view of an embodiment of a mat of the present invention wherein an insert encased in an insert cover is detachably attached to the top wall of a mat body fabric cover encasing a mat body.

FIG. 4C is a side view of an embodiment of a mat of the present invention wherein an insert encased in an insert cover is detachably attached to the top wall of a mat body fabric cover encasing a mat body.

FIG. 5 is plan view of an embodiment of a mat of the present invention in which an insert encased in an insert cover is aligned with the well of a mat body encased in a mat body fabric cover.

FIG. 6 is a plan view of an embodiment of a mat of the present invention wherein an insert encased in an insert cover is aligned opposite the well of a mat body encased in a mat body fabric cover.

FIG. 7 is a plan view of an embodiment of a mat of the present invention in which two mat bodies, each encased in a mat body fabric cover, are aligned to create a continuous mat area and a well surrounded in all directions by the continuous mat area.

FIG. 8A is a plan view of an exemplary accessory attachment bar for attaching accessories such as toys or pacifiers.

FIG. 8B is a front view of the accessory attachment bar.

FIG. 8C is a side view of the accessory attachment bar.

FIG. 9A is a front view of an exemplary mat body of the invention wherein the mat body is comprised of two sections.

FIG. 9B is a rear view of a butt joint between two mat body sections.

FIG. 9C is rear view of an alternative joint (half lap) between two mat body sections.

FIG. 9D is a rear view of half lap type joint between two removably attached mat body section fabric covers, with each cover encasing one mat body section.

FIG. 10A is a plan view of an exemplary mat body of the mat according to the invention with curved well walls connecting through a radius.

FIG. 10B is a plan view of an exemplary insert of a mat according to the invention with curved well contacting walls connecting through a radius.

FIG. 11 is an embodiment of an anti-slip pad of the mat according to the invention.

FIG. 12A is a plan view of an embodiment of a mat body fabric cover comprising two handle forming members.

FIG. 12B is a front view of an embodiment of a mat body fabric cover comprising two handle forming members.

FIG. 13 is a perspective view of an embodiment of a mat body fabric cover comprising two handle forming members wherein the two handle forming members have contacted each other to form a handle.

### DETAILED DESCRIPTION OF THE INVENTION

### Definitions

“Foam” refers to the classes of polymeric foam materials including, but not limited to: polyvinylchloride foam, polyvinylalcohol foam, melamine foam, polyester foam, polystyrene foam, polyurethane foam, nylon foam, polypropylene foam, cellulose foam, polyethylene foam, polyacrylonitrile foam, as well as mixtures thereof.

“Fabric” means a cloth made by weaving, knitting, or felting fibers. Fabric also refers to the class of non-woven materials. The fibers used to manufacture fabrics may be natural or man-made. Examples of natural fibers include, but are not limited to cotton, wool, linen, and silk. Examples of man-made fibers include, but are not limited to, rayon (cellulose), cellulose acetate, polyacrylonitrile (acrylic), polyamide (nylon), and polyester. Fabric may be manufactured from one or more types of fiber. Examples of fabrics include, but are not limited to, muslin, fleece, organdy, flannel, oxford, percale, poplin, terry cloth, linen, sail cloth, and nylon.

### DESCRIPTION

In preferred embodiments, the present apparatus is a mat comprising a mat body and a removable mat insert. The mat includes a well adapted to receive the removable insert.

The mat may be any shape, including, for example, a circle, oval, square, rectangle, or an irregular shape. Examples of irregular shapes include, but are not limited to, flowers, stars, and animal shapes.

The mat body and insert may comprise a mat material that may be selected from foam, an inflatable member, and a particle filled member. Examples of particles include, but are not limited to, foam, down, plastic beads, paper, rubber shreds, batting, or any combination thereof. In preferred embodiments, the mat material is foam.

The mat material may be water resistant to facilitate easy cleaning.

Preferably, the materials used to manufacture the mat body and insert will be the same. The materials used to manufacture the mat body and insert may, however, be different.

In preferred embodiments, a mat body of the present invention will have at least one top wall, at least one bottom wall, and at least one side wall for connecting the top and bottom walls. Preferred embodiments will also possess a well disposed within the volume of the mat body. The well is defined by at least one well wall connected to the top and bottom walls of the mat body and likewise connected to the at least one side wall. Preferably, the well is adapted to receive the insert and is also large enough to accommodate a baby placed in the well in a seated position or on its back or stomach.

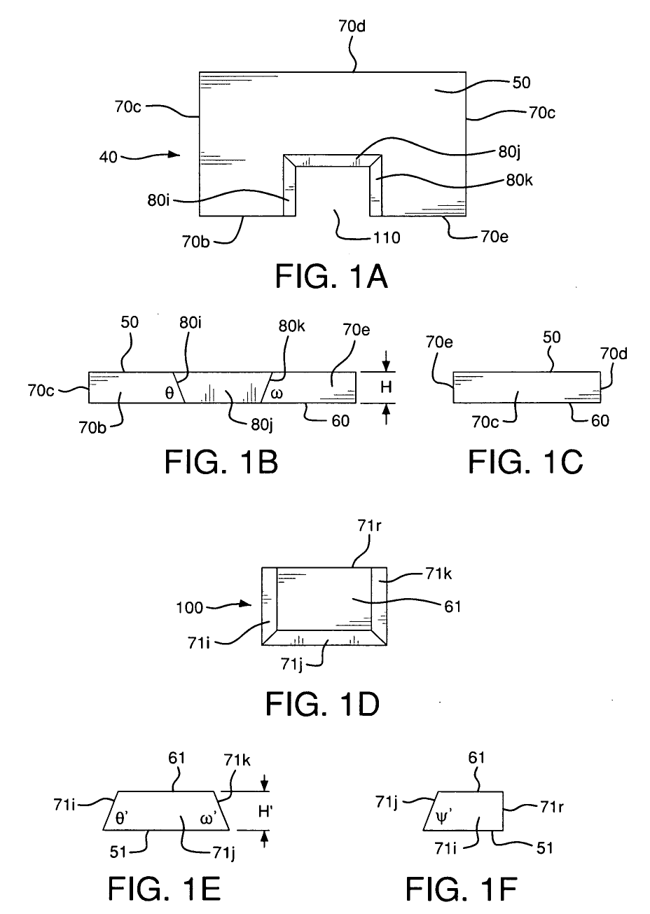

An exemplary mat body and insert comprising a rectangular shaped mat are shown in FIGS. 1A, 1B, 1C, 1D, 1E, and 1F. As shown in FIGS. 1A, 1B, and 1C, the rectangular mat body 40 possesses a top wall 50 and a bottom wall 60. Top wall 50 and bottom wall 60 are connected at their edges through side walls 70b, 70c, 70d, and 70e. The well, 110, disposed within the mat body is defined by well walls 80i, 80j, and 80k. Well walls 80i, 80j, and 80k are each connected to top and bottom walls 50 and 60 respectively. Well wall 80i is likewise connected to side wall 70b and well wall 80k is connected to side wall 70e.

In FIGS. 1A, 1B, and 1C, the lengths of side walls 70c and 70d correspond to the length and width of the mat body, respectively. Wall 70d may be, for example, about 24″ to about 48″ long. More preferably side wall 70d is about 30″ to about 42″ long. In a most preferred embodiment, side wall 70d is about 36″ long.

Side wall 70c is preferably about 12″ to about 36″ in length. More preferably side wall 70c is about 18″ to about 30″ long. In a most preferred embodiment, side wall 70c is about 24″ long.

In FIG. 1A, the length of side wall 70b is measured from the intersection of wall 70c with wall 70b to the intersection of side wall 70b with well wall 80i as measured along top wall 50 and parallel to wall 70b. In certain embodiments, side wall 70b is about 6″ to about 12″ long. In preferred embodiments, side wall 70b is about 8″ to about 9″ long.

In FIGS. 1A, 1B, and 1C, side walls 70b and 70e are shown, for purposes of illustration, as being equal in length. In other embodiments, however, side walls 70b and 70e may be different lengths.

The mat body is defined by a height, H (FIG. 1B). The height, H, is measured as the perpendicular distance between top wall 50 and bottom wall 60. As shown in FIGS. 1A, 1B, and 1C, H is nearly constant such that the height measured at a given location of the mat body will be about equal to a measurement taken at any other location. In other embodiments, however, H may vary.

In preferred embodiments, height H is about 0.5″ to about 3″. In a more preferred embodiment, height H is about 2″.

Well 110 is adapted to removably receive insert 100, shown in FIG. 1D. As noted above, well 110 is defined by well walls 80i, 80j, 80k. Well 110 is also defined by angles θ, ψ (not shown), and ω. Angle θ is defined by the intersection of bottom wall 60 and well wall 80i; angle ψ is defined by the intersection of well wall 80j and bottom wall 60; and angle ω is defined by the intersection of bottom wall 60 and well wall 80k. According to one embodiment, shown in FIGS. 1A, 1B, and 1C, angles θ, ψ, and ω are each about 45°.

Well walls 80i, 80j, and 80k are preferably angled to provide a gentle slope for a child placed on its back or stomach in the well. For a child on his or her stomach, the angled well walls permit the child to more easily look out of the well, helping to develop musculature and coordination. The angled walls may also encourage the child to crawl. For a child on its back, the angled well walls provide a more comfortable surface to lie on. For a seated child or child learning to sit, the angled well walls assist in gently receiving a child falling from a seated position.

Angles θ, ψ, and ω may independently range from about 0° to about 90°. In preferred embodiments, angles θ, ψ, and ω are about equal and may be from about 30° to about 60°. In a more preferred embodiment, angles θ, ψ, and ω are each about 45°.

The lengths of well walls 80i and 80j correspond to the depth and width of well 110, respectively. The length of wall 80i is measured from the intersection of wall 70b with well wall 80i to the intersection of well wall 80i with well wall 80j. This length is measured along top wall 50. The length of well wall 80j is measured as the distance between the intersection of well wall 80i with well wall 80j to the intersection of well wall 80j with well wall 80k. This length is also measured along top wall 50.

Well depth may be from about 8″ to about 18″. In preferred embodiments, well depth may be about 11″ to about 15″. In a more preferred embodiment well depth may be about 13″.

Well width may be about 15″ to about 23″. In preferred embodiments, well width may be about 17″ to about 21″. In a more preferred embodiment, well width may be about 19″.

In the embodiment shown in FIGS. 1A through 1C, mat body 40 consists of one piece of mat material. In alternative embodiments, the mat body may consist of more than one piece of mat material. In embodiments where the mat body consists of more than one piece of mat material, the individual units comprising the mat body are referred to as mat body sections. The use of multiple mat body sections facilitates easy storage and/or transportation of the mat body.

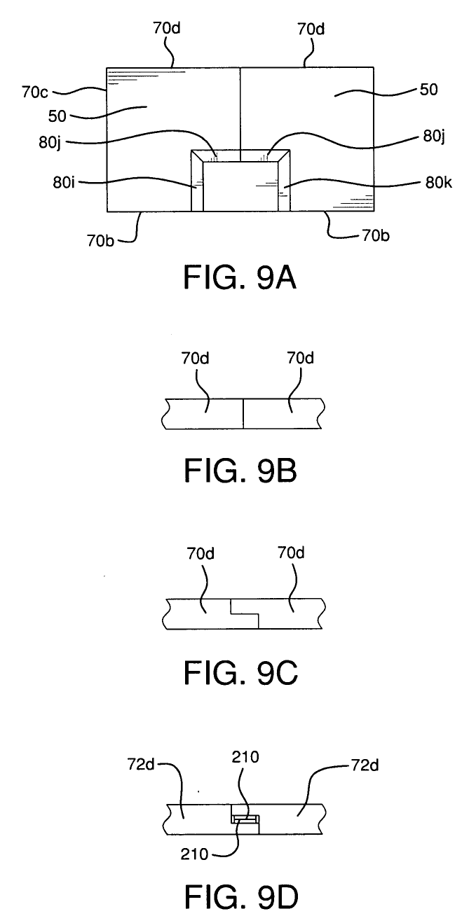

An exemplary mat body comprising two mat body sections is shown in FIG. 9A. The mat body components may meet at any type of joint. Examples of joints include, but are not limited to, butt joints, half lap joints, and interlocking joints, such as a tongue and groove joints, or dove tails. A butt joint and half lap joint, as viewed along wall 70d, are shown in FIGS. 9B and 9C respectively.

An exemplary insert 100 is depicted in FIGS. 1D, 1E, and 1F, and is defined by a top wall 51 and a bottom wall 61 wherein the top wall and bottom wall are connected by well contacting walls 71i, 71j, and 71k and a rear wall 71r. The well contacting walls are angled at angles θ′, ψ′, and ω′. The perpendicular distance between top wall 51 and bottom wall 61 defines a height H′ of the insert.

The lengths of well contacting walls 71i and 71j correspond to the depth and width of insert 100, respectively. The length of wall 71i is measured from the intersection of well contacting wall 71i and wall 71r to the intersection of well contacting wall 71i with well contacting wall 71j. This length is measured along top wall 51. The length of well contacting wall 71j is measured as the distance between the intersection point of well contacting wall 71i with well wall 80j to the intersection point of well wall 71j with well contacting wall 71k. This length is also measured along top wall 51.

Angle θ′ is defined by the intersection of top wall 51 and well contacting wall 71i; angle ψ′ is defined by the intersection of well contacting wall 71j and top wall 51; and angle ω′ is defined by the intersection of top wall 51 and well contacting wall 71k. In the embodiment shown in FIGS. 1D, 1E, and 1F, angles θ′, ψ′, and ω′ are each about 45° such that insert 100 may be disposed within well 110 of mat body 40.

Angles θ′, ψ′, and ω′ may independently range from about 0° to about 90°. In preferred embodiments, angles θ′, ψ′, and ω′ are about equal and may be from about 30° to about 60°. In a more preferred embodiment, angles θ′, ψ′, and ω′ are each about 45°.

In still another preferred embodiment, angle θ=θ′; angle ψ=ψ′, and ω=ω′.

In FIGS. 1A through 1F, the length and width of insert 100 are equal to the depth and width of well 110, respectively. Likewise, H=H′ and θ=θ′=ψ=ψ′=ω=ω′. As a result, when insert 100 is removably disposed within well 110, mat body top wall 50 is co-planar with insert top wall 51. Likewise, mat body bottom wall 60 is coplanar with insert bottom wall 61. Also, well contacting walls 71i, 71j, and 71k contact well walls 80i, 80j, and 80k respectively.

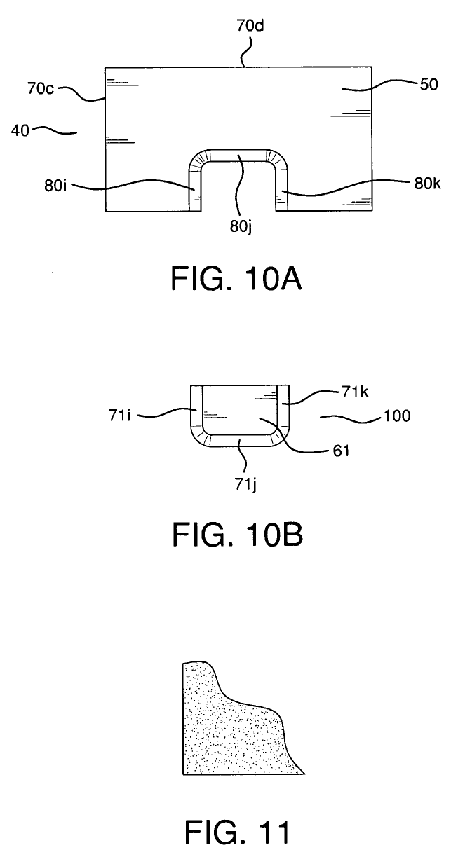

In the mat body embodiment shown in FIGS. 1A, 1B, and 1C, well walls 80i and 80j and well walls 80j and 80k intersect at right angles. In another mat body embodiment, shown in FIG. 10A, well walls 80i, 80j, and 80k are curved and continuously connected through radii. A correspondingly shaped insert for insertion into the mat body of FIG. 10A is shown in FIG. 10B.

In preferred embodiments, a baby is not directly exposed to the mat material of either the mat body or insert. In these preferred embodiments, the mat body and insert may be individually encased in, or fitted with, removable fabric covers. The fabric covers are preferably machine washable. In instances where the fabric covers are not machine washable, the fabric covers may be comprised of material that may be readily wiped down for convenient cleaning. Alternatively, dry cleaning may be appropriate.

Fabric covers of the present invention may include a fabric cover top wall and at least one fabric cover side wall or at least one well contacting wall. The fabric covers may also include a fabric cover bottom wall.

Typically, fabric covers of the present invention will comprise only one type of fabric. In some embodiments, however, the fabric covers may comprise more than one type of fabric. As an example, in a fabric cover possessing a bottom wall, at least one side wall, and a top wall, the bottom wall may comprise a different fabric than the top wall or at least one side wall.

In another embodiment, fabric covers of the present invention may further comprise an anti-slip material. As an example, in a fabric cover possessing a bottom wall, at least one side wall, and a top wall, the bottom wall may comprise an anti-slip material while the remaining walls are comprised of fabric.

One example of a fabric cover of the present invention is a “fitted” fabric cover. Fitted fabric covers may be constructed much like a fitted bed sheet.

A fitted mat body fabric cover preferably covers the mat body top wall, mat body side walls, and mat body well walls. Some portion of the mat body bottom wall may likewise be covered.

A fitted insert fabric cover may cover the well contacting walls and top wall of the insert. The fitted insert cover may also cover some portion of the insert bottom wall.

Fitted fabric covers may further include one or more securing members for securing the fitted fabric cover to the mat body or insert. Examples of securing members include, but are not limited to, an elastic member, a drawstring, one or more snaps, one or more buttons, or hook and loop type connectors.

Another example of a fabric cover contemplated by the present invention is an “encasement” style fabric cover. In this cover embodiment, all or nearly all of the surfaces of the mat body and/or insert are covered by the mat body and insert fabric covers, respectively. Preferably encasement style fabric covers are form-fitting. Encasement style fabric covers preferably also include one or more closeable openings for inserting a mat body, a mat body section, or an insert. Preferably, the opening or openings may be closable via one or more closure members. Examples of closure members include, but are not limited to, overlapping fabric, a hook and loop closure, a button and button hole, a zipper, holes adapted to receive one or more laces, and one or more snaps.

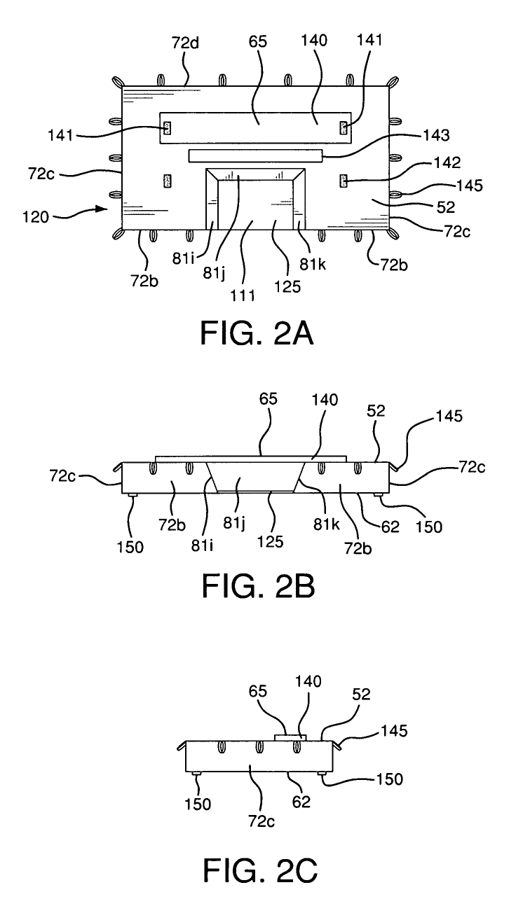

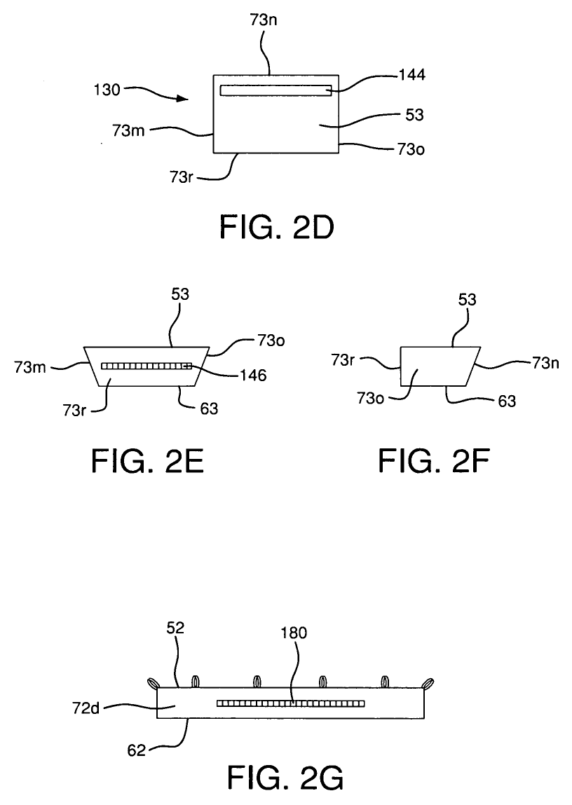

An exemplary form-fitting “encasement” style mat body fabric cover 120 is shown in FIGS. 2A through 2C and 2G. An exemplary form-fitting “encasement” style insert fabric cover 130 is shown in FIGS. 2D through 2F.

Mat body fabric cover 120, shown in FIGS. 2A, 2B, 2C, and 2G includes a top wall 52 and a bottom wall 62 connected through side walls 72b, 72c, and 72d and well walls 81i, 81j, and 81k. A closeable opening, 180, for inserting a mat body is resident along wall 72d (FIG. 2G). Mat body fabric cover 120 also includes a well 111 and a well floor pad, 125. The well floor pad 125 may be a piece of fabric permanently fastened to well walls 81i, 81j, and 81k at or near the location where the well walls intersect bottom wall 62. Alternatively, the well floor pad may comprise mat material non-removably encased in fabric.

The well floor pad provides a protective barrier between a child seated in well 111 of an encased mat body and a flooring surface that may be dirty or otherwise uncomfortable for a child to sit or lie on. Additionally, a child seated on the well floor pad will act as a weight to keep the covered mat body from shifting or sliding on a non-carpeted surface, such as, for example, hardwood floors.

The well floor pad 125 has a top wall 54 and a bottom wall 64 wherein the well floor pad bottom wall is coplanar with the mat body fabric cover bottom wall 62. In other embodiments, however, well floor pad bottom wall 64 may not be in the same plane as mat body fabric cover bottom wall 62. Preferably, well floor pad 125 is about 0.1″ to about 0.5″ thick.

In a preferred embodiment, wherein both mat body 40 and insert 100 are covered or encased in fabric covers 120 and 130 respectively, the length, width, and height (H′) of insert 100 may be selected such that the covered insert, when disposed within well 111, fits in well 111 in a complementary fashion. Typically in this embodiment, angle θ=θ′=ψ=ψ′=ω=ω′. Additionally, the top walls of the mat body fabric cover and insert fabric cover will be co-planar or nearly co-planar. Likewise, well walls 81i, 81j, and 81k will be contacted by well contacting walls 73m, 73n, and 73o, respectively.

The mat body fabric cover 120 can also include accessory attachment points 145. The accessory attachment points may be used to attach accessories, examples of which include, but are not limited to, toys or pacifiers. Examples of accessory attachment points include, but are not limited to buttons, snaps, hook and loop members, loops, hooks, clamps, and clasps wherein the buttons, snaps, loops, hooks, clamps, and clasps may be composed of fabric, metal, plastic, wood, leather, rubber, or rope as well as mixtures and combinations thereof.

The accessory attachment points may be located anywhere on the mat body fabric cover. In FIGS. 2A, 2B, and 2C, the accessory attachment points are fastened to the mat body cover at the junction of the mat body fabric cover top wall 52 and side walls 72b, 72c, and 72d. This particular fastening point allows a child seated or otherwise placed in well 111 of fabric cover 120 to easily view attached accessories.

Any number of accessory attachment points 145 may be attached to a mat body fabric cover. In the embodiment shown in FIG. 2A, the accessory attachment points are separated by about 4″ to about 10″ along side walls 72b, 72c, and 72d. Although the 4″ to 10″ separation is preferred, the accessory attachment points may be closer than 4″ or separated by more than 10″.

The accessory attachment points may also serve as attachment points for one or more removably attachable accessory attachment bars 200. An exemplary accessory attachment bar is shown in plan, front, and side views in FIGS. 8A, 8B, and 8C, respectively.

Accessory attachment bars may be attached to the mat body fabric cover to provide attachment points for toys or other accessories, such as, for example, a mirror. Accessory attachment bars may span the distance from one side of the mat body to the other, forming, for example, an arch over the mat body. Alternatively, the bars may be attached along the edge of the mat body fabric cover, or attached in such a way so as to only span a portion of the mat body. Toys or other accessories attached to the accessory attachment bars hang down and attract the attention of a child looking up from his or her back, seated in the well, or on his or her stomach. In certain configurations, more than one accessory attachment bar may be attached to the mat body fabric cover at a time.

The exemplary accessory attachment bar shown in FIGS. 8A through 8C includes two mat attachment mechanisms, 201, for attaching to the accessory attachment points on the mat body fabric cover. Mat attachment mechanisms include, but are not limited to, one or more hooks, clasps, clamps, snaps, or buttons. The exemplary accessory attachment bar of FIGS. 8A through 8C also includes accessory attachment points, 145.

In certain embodiments, the accessory attachment bars comprise fabric covered mat material. The accessory attachment bar may further comprise a structural support member, such as a piece of metal or plastic, disposed within the mat material. The structural support member provides a rigidity to the accessory attachment bar so that accessories attached to the bar do not cause it to collapse.

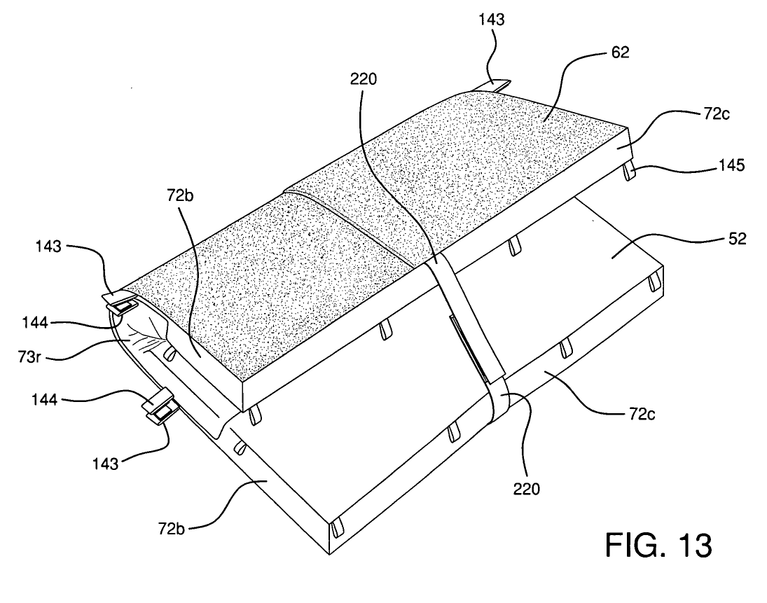

The mat body fabric cover may also include one or more insert cover attachment members attached to a wall or at the intersection of walls or along the outermost edge of the well floor pad of the mat body fabric cover. The insert cover attachment member(s) are adapted to removably attach an insert cover encasing an insert to the mat body fabric cover. In the embodiment shown in FIG. 2A, one insert cover attachment member, 143, is shown. In FIG. 13, three insert cover attachment members, 143, are visible.

In certain embodiments, the insert cover attachment member or members may be utilized when insert 100 encased in insert cover 130 is disposed within well 110. In this embodiment, the insert cover attachment member or members keep insert 100 encased in fabric cover 130 from sliding out of the well. Alternatively, the insert cover attachment member or members may act to keep insert 100 in fabric cover 130 positioned on the top wall of the mat body fabric cover or along any other wall of the mat body fabric cover. Examples of insert cover attachment members include, but are not limited to, the hook or loop portion of a hook and loop connector, a button or button hole, or the top or bottom portion of a snap.

The mat body fabric cover may further include a removably or non-removably attached flap on the top wall of the mat body fabric cover. In some embodiments, the flap is comprised of fabric. In preferred embodiments, the flap is comprised of the same fabric as the mat body fabric cover top wall. The flap may be any shape, including, but not limited to a half circle, half oval, rectangle, or irregular shape.

Preferably, the flap is attached such that it may be folded about 180° at or near its point or points of attachment. In preferred embodiments, the flap is attached to the mat body fabric cover top wall so that the one or more insert cover attachment member(s) resident on the top wall of the mat body fabric cover may be selectively concealed by folding or unfolding the flap. When the flap is covering the insert cover attachment members, the flap may also cover some portion of a covered insert disposed within the well of an encased mat body.

In the embodiment shown in FIGS. 2A, 2B, and 2C, a non-removably attached rectangular flap 140 is present. Flap 140 includes a flap top wall 55 and a flap bottom wall 65. In the embodiment shown in FIG. 2A, flap 140 is in the “open,” position, displaying bottom wall 65 when the mat body fabric cover is viewed from above. When flap 140 is in the “closed” position, flap top wall 55 is visible from above and insert cover attachment member 140 is no longer visible.

Flap 140 also includes two flap securing members 141 permanently affixed to the flap bottom wall. In other embodiments, however, fewer or greater than two flap securing members may be present.

Flap securing members 141 are preferably selected to removably engage flap securing member receivers 142 on the top wall 52 of the mat body fabric cover 120. The flap securing members 141 and flap securing member receivers 142 may comprise, bur are not limited to, the upper and lower portion of a snap, a button hole and a button, a hook and loop type connector, or a magnet and a ferromagnetic material.

The mat body fabric cover may further include removably or permanently attached anti-slip feet. Anti-slip feet, 150, are attached to the mat body fabric cover bottom wall 62, as shown in FIGS. 2A, 2B, 2C, and 2G. The anti-slip feet keep mat body fabric cover 120 from sliding on a non-carpeted surface, such as hard wood floors.

In combination with the anti-slip feet, or as an alternative to the anti-slip feet, the mat body fabric cover may include a removably attachable or permanently attached anti-slip pad 151, shown (unattached) in FIG. 11. In preferred embodiments, the anti-slip pad is coincident in dimension with bottom wall 64 of well floor pad 125. The anti-slip pad may, however, be larger than the bottom wall of well floor pad 125 such that anti-slip pad 151 either covers or acts as the bottom wall, 62, of the mat body fabric cover. In other embodiments, the anti-slip pad may be removably attached to the mat body fabric cover bottom wall 62 instead of or in addition to being attached to the well floor pad 125.

Preferably, the anti-slip feet and/or pad are comprised of non-skid material such as rubber or other synthetic or natural material that will prevent the mat from slipping on a non-carpeted surface.

As noted previously, encasement style mat body fabric covers also preferably includes at least one closeable opening for inserting the mat body. In the embodiment shown in FIG. 2F, a single closeable opening is resident along wall 72d. In other embodiments, more than one opening may be present, or found on different side, top, or bottom walls.

Where the mat body comprises more than one piece of mat material, the mat body fabric cover may be tailored to individually encase each mat body component. In addition, the mat body fabric cover may be foldable at or near the junction of the mat body components.

Alternatively, the mat body fabric cover may comprise two or more cover components that can be removably attached to each other by, for example, one or more hook and loop type attachments, one or more buttons, one or more snaps, or one or more zippers. FIG. 9D depicts a half lap type joint viewed along wall 72d wherein two mat body fabric cover components separately encase individual mat body sections. In this embodiment, the mat body fabric cover components are removably attached via attachment member 210.

An exemplary insert fabric cover 130 shown in FIGS. 2D, 2E, and 2F, comprises a top wall 53 and a bottom wall 63, connected through a rear wall 73r, and well contacting walls 73m, 73n, and 73o. Fabric cover 130 also includes a closeable opening 146 for inserting insert 100. Fabric cover 130 likewise includes a mat body fabric cover attachment member, 144, disposed along bottom wall 63 for removably attaching the insert cover 130 to the insert cover attachment member 143, shown in FIG. 2A.

In other embodiments, the insert fabric cover may comprise more than one mat body fabric cover attachment member disposed upon or along any wall or at the intersection of any walls of the insert fabric cover. FIG. 13, for example, shows an insert possessing at least two mat body fabric cover attachment members, 144. In all instances, the mat body fabric cover attachment member or members are fastened to the insert fabric cover in a way that compliments the positioning and spacing of the insert cover attachment member or members of the mat body fabric cover so that the insert may be removably attached to the mat body fabric cover.

Examples of mat body fabric cover attachment members include, but are not limited to, the hook or loop portion of a hook and loop connector, a button or button hole, or the top or bottom portion of a snap. The mat body fabric cover attachment member or members are selected to be complementary with the insert cover attachment member or members, 143.

Closeable opening 146 may be closed using closures, including, but not limited to, one or more hook and loop closures, one or more zippers, one or more snaps or buttons, or the fabric of the cover may overlap in such a way so as to preclude insert 100 from escaping insert cover 130.

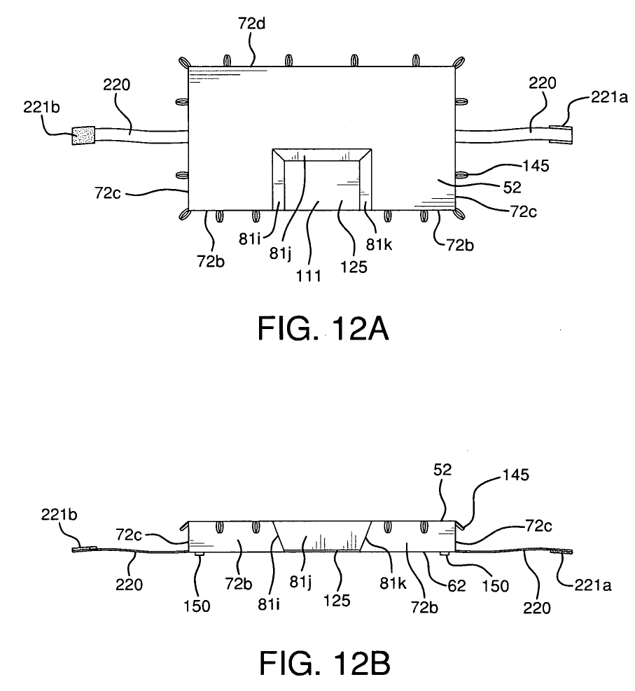

In a further embodiment of the invention, a mat body fabric cover may include two handle or shoulder strap forming members, 220. In some embodiments, the handle or shoulder strap forming members are comprised of the same fabric material as the mat body fabric cover itself. In other embodiments, the handle or strap forming members 220 may be made out of a different fabric. See, for example, FIGS. 12A and 12B.

The handle or shoulder strap forming members 220 are preferably attached to the mat body fabric cover along two opposite side walls, such as for example, side walls 72c or at the intersection of bottom wall 62 and side walls 72c or the intersection of side walls 72c and top wall 52.

Attached to each handle or shoulder strap forming member, 220 are a first connecting means 221a and a second connecting means 221b. The first and second connecting means, 221a and 221b, respectively can be any form of connection such as snaps, buttons, hook and loop fastener, clasps, buckles, ties, or other similar devices. Preferably, the connection means are a hook and loop fastener, with, for example, the hook portion shown as 221a and the loop portion shown as 221b.

Using the preferred hook and loop fastener as an example of how the first connecting means 221a and the second connecting means 221b operate, the hook and loop portions are attached to the handle or strap forming members in such a way so that when the hook portion, 221a, of one handle or strap forming member 220 contacts the loop portion, 221b, of the other handle or strap forming member 220, the handle or shoulder strap forming members become removably attached to one another, forming a handle or shoulder strap.

The handle and shoulder strap thus formed provide a convenient mechanism for transporting the invention from one location to another. The length of the handle or shoulder strap may be adjusted by the user by varying where hook and loop members 221a and 221b come into contact with one another. Alternatively, the handle or shoulder strap forming members may be manufactured to such a length to form either only a handle or only a shoulder strap.

An exemplary fabric cover comprising two handle forming members 220 with hook and loop attachment portions, 221a and 221b is shown in FIGS. 12A, 12B, and 13. FIG. 12A is a plan view of an exemplary mat body disposed within a mat body fabric cover comprising two handle forming members 220 and hook and loop members 221a and 221b. In this figure, the handle forming members are not removably attached to one another. FIG. 12B is a front view of the embodiment shown in FIG. 12A.

FIG. 13 is a perspective view of a mat body disposed within an embodiment of a mat body fabric cover comprising handle forming members 220. In this figure, hook and loop members 221a and 221b have been placed in contact, such that hook and loop members 221a and 221b are removably engaged with one another forming a handle. Also in this figure, insert 100 covered by insert cover 130 is disposed within well 111 of the mat body fabric cover. Mat body fabric cover attachment members 144 and fabric cover attachment members 143 are likewise visible and removably attached to one another via a hook and loop mechanisms.

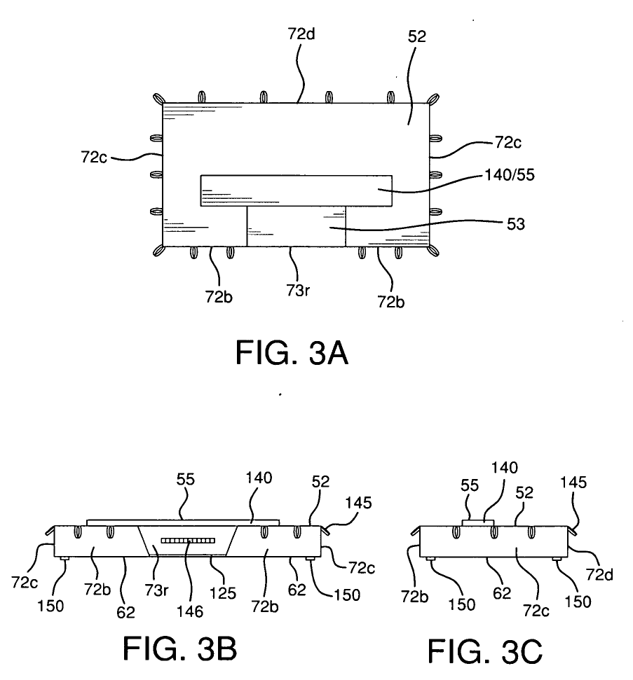

The invention described above may be configured in multiple embodiments. In the embodiment shown in FIG. 3, insert 100 (not shown) in fabric cover 130 is disposed within well 111 of mat body 40 (not shown) inserted into mat body fabric cover 120. Flap 140 is configured to conceal the insert cover attachment member 143.

In the configuration shown in FIG. 3, the mat may function as a changing pad for a baby; a rest mat for a toddler as the child reads, watches television, or naps; a safe crawling obstacle; or a play mat when toys are attached, either directly or indirectly, to accessory attachment points 145.

In FIG. 3, the covered insert is not attached to the mat body fabric cover and the insert is held in the well via friction. In alternative embodiments, however, the insert fabric cover may be removably attached to the mat body fabric cover in order to keep the insert from sliding out of the well.

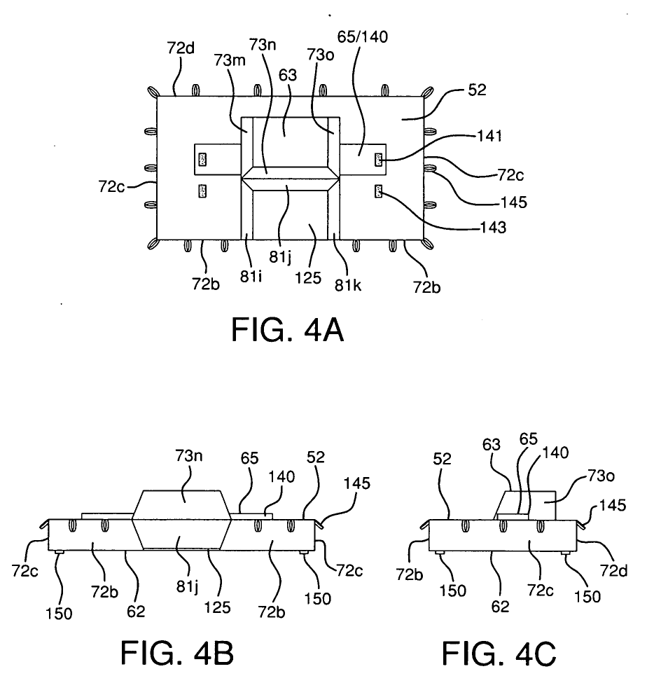

In the configuration shown in FIGS. 4A, 4B, and 4C, insert 100 (not shown) in insert cover 130 is positioned on top of mat body 40 (not shown) in encasement cover 120. Mat body fabric cover attachment 144 removably engages insert fabric cover attachment member 143. Likewise, insert cover well engaging wall 73n is horizontally aligned with mat body fabric cover well wall 81j.

In this configuration, the mat may function as a sitting mat, wherein a baby is seated in well 111 on well floor pad 125 with his or her back against well wall 81j and well engaging wall 73n.

The configuration shown in FIGS. 4A-4C may also function as: a head rest for an older child lying on his or her back on well floor pad 125 or mat body fabric cover top wall 52; a lounge mat for a toddler as the child reads or watches television; an elevated mat for an infant as the child gets ready to crawl; or a mat for “tummy time” so that the child can learn to hold his or her head up while at the same time developing upper body musculature and coordination.

In the configuration shown in FIGS. 2A, 2B, 2C, and 2G, mat body 40 (not shown) is encased in mat body fabric cover 120. No insert is required in this configuration, though one may be utilized at the user's discretion. In this embodiment, the covered mat body cushions the fall of an infant seated in well 111 when he or she falls. Preferably, flap 140 configured to reveal the insert fabric cover attachment 143. The attached anti-slip feet 150 keep the mat in place on non-carpeted floors. Although not shown in this embodiment, toys or other accessories may be attached to accessory attachment points 145. It is suggested that this configuration only be used for children with more developed musculature.

This configuration may also be useful for a child placed in well 111 on well floor pad 125 on his or her stomach. In this configuration, the well provides a low, natural, and comfortable environment for infants who typically dislike being on their stomachs. Toys attached to accessory attachment points 145 encourage a child to keep his or her head up so that the child develops good upper body and neck musculature.

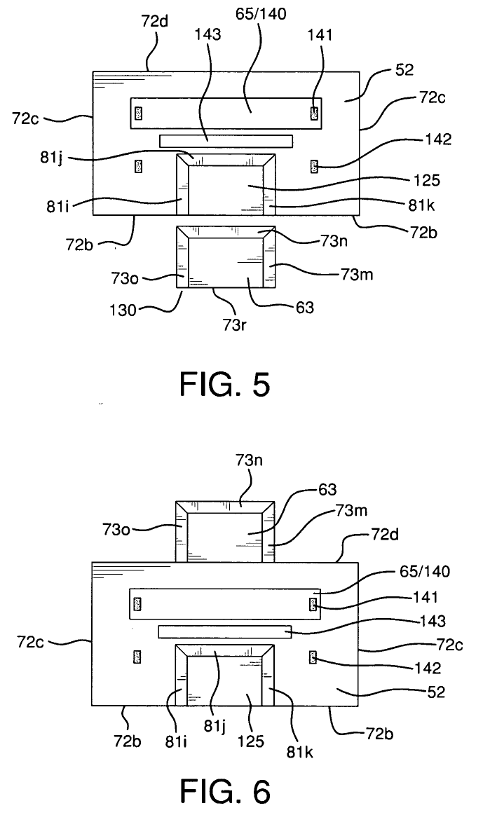

In the embodiment shown in FIG. 5, insert 100 (not shown) in insert fabric cover 130 is positioned opposite well wall 81j such that a child seated on well floor pad 125 will have protection in all directions when falling. This configuration also creates a “roll-free” area where a baby either on its back or stomach will be unlikely to roll over or away due to the protection provided in all directions.

In FIG. 5, insert fabric cover 130 is not attached or connected mat body fabric cover 120. In certain embodiments, however, insert fabric cover 130 may be removably attached to insert fabric cover 120 to prevent the insert from shifting position. If the insert shifts, it may create a gap between the covered mat body and the insert, leaving an area where a falling child might be injured.

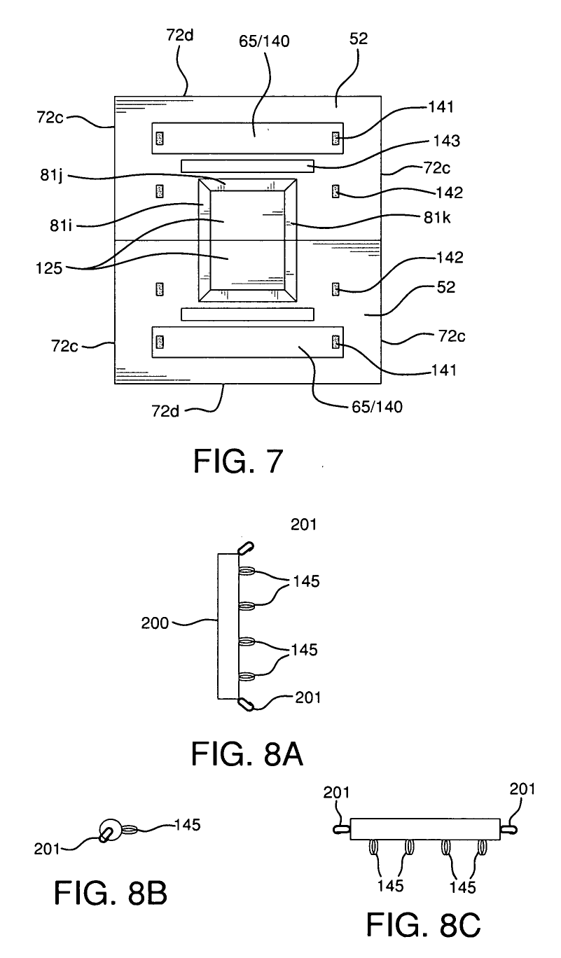

In another configuration shown in FIG. 7, two mat bodies 40 (not shown) in fabric covers 120, may be placed opposite one and other such that the well floor pads 125 are directly opposite one and other. In this embodiment, the inserts may be aligned along the periphery of the bi-mat configuration or stored for later use. Alternatively, one or two inserts may be attached to the top wall of the mat body fabric covers.

Although not shown in FIG. 7, in preferred embodiments, the mat body fabric covers may be removably attached to one and other to keep the bi-mat unit from separating.

In the configuration shown in FIG. 6, insert 100 (not shown) in insert fabric cover 130 is placed in a position opposite from well wall 81j along wall 72d of mat body fabric cover 120. In this embodiment, the insert provides extra cushioning for longer or older infants who may require additional space. Alternatively, a mat in this configuration may be used as an exercise mat for a parent to do pilates or yoga with a baby. In certain embodiments, the covered insert may be removably attached to the side wall of the mat body fabric cover 120.

Although the positions involving a single mat will typically only require the use of one or fewer inserts, it is further envisioned that more than one insert may be used at any given time. When more than one insert is used, combinations of the configurations described above are possible and considered to be within the scope of the present invention.

We claim:

1. A mat having a shape, said mat comprising a mat body and a removable insert wherein
a. said mat body includes a well adapted to receive the insert, a top wall and a bottom wall connected through one or more side walls and one or more well walls; and
b. said insert includes an insert top wall and an insert bottom wall connected through one or more well contacting walls; and
c. said mat body is composed of a first mat material and said insert is composed of a second mat material.

2. The mat of claim 1 further comprising at least one mat body fabric cover and at least one insert fabric cover enclosing the mat body and insert, respectively.

3. The mat of claim 2 wherein said at least one mat body fabric cover comprises
a. a mat body fabric cover top wall and a mat body fabric cover bottom wall connected through one or more mat body fabric cover side walls;
b. one or more mat body fabric cover well walls;
c. a well floor pad connected to said at least one or more mat body fabric cover well walls;
d. at least one closeable opening for inserting the mat body into said fabric cover; and
e. at least one insert cover attachment member for removably attaching said insert fabric cover to said mat body fabric cover.

4. The mat of claim 3 wherein said well floor pad comprises a floor pad top wall and a floor pad bottom wall.

5. The mat of claim 2 wherein said insert fabric cover comprises an insert fabric cover top wall and an insert fabric bottom wall connected through an insert fabric cover rear wall and at least one insert fabric cover well contacting wall.

6. The mat of claim 5 wherein said insert fabric cover further comprises an opening for inserting the insert into the insert fabric cover, and one or more mat body fabric cover attachment members on said fabric cover adapted to removably attach the insert fabric cover to the mat body fabric cover.

7. The mat of claim 3 wherein said mat body fabric cover further comprises at least one accessory attachment point.

8. The mat of claim 3 wherein said mat body fabric cover further comprises a flap for concealing said at least one insert cover attachment member.

9. The mat of claim 1 wherein the first and second mat materials are independently selected from the group consisting of foam, particles, and an inflatable member.

10. The mat of claim 9 wherein said particles are composed of foam, down, plastic beads, paper, rubber shreds, batting, or combinations thereof.

11. The mat of claim 9 wherein the first and second mat materials are each composed of a foam.

12. The mat of claim 11 wherein said foams are independently selected from the group consisting of polyvinylchloride foam, polyvinylalcohol foam, melamine foam, polyester foam, polystyrene foam, polyurethane foam, nylon foam, polypropylene foam, cellulose foam, polyethylene foam, polyacrylonitrile foam, and combinations thereof.

13. The mat of claim 12 wherein the first and second mat materials are polyurethane foam.

14. The mat of claim 1 wherein said mat shape is an oval, a circle, a square, a rectangle, or an irregular shape.

15. The mat of claim 14 wherein said shape is a rectangle.

16. A mat having a shape, said mat comprising a mat body of at least two sections and a removable insert wherein
a. said mat body includes a well adapted to receive the insert, a top wall and a bottom wall connected through one or more side walls and one or more well walls; and
b. said insert includes an insert top wall and an insert bottom wall connected through one or more well contacting walls; and
c. said mat body is composed of a first mat material and said insert is composed of a second mat material.

17. The mat of claim 16 wherein said mat body sections meet at a butt joint or a half-lap type joint.

18. The mat of claim 2 wherein said mat body fabric cover and insert cover are composed of one or more fabrics independently selected from the group consisting of muslin, fleece, organdy, flannel, oxford, percale, poplin, terry cloth, sail cloth, wool, linen, silk, rayon, cellulose acetate, polyacrylonitrile, nylon, polyester, and combinations thereof.

19. The mat of claim 2 further comprising an accessory attachment bar.

20. A rectangular mat comprising a foam mat body disposed within a mat body fabric cover and a foam insert disposed within an insert fabric cover wherein
the mat body includes a well adapted to receive the insert, a top wall and a bottom wall connected through at least three side walls and at least three well walls, wherein said well walls are angled at a first angle, and said first angle is defined relative to the intersection of said well walls and said bottom wall;
said insert includes a second top wall and a second bottom wall connected through at least three well contacting walls, wherein said well contacting walls are angled at a second angle, and said second angle is defined relative to the intersection of said second top wall and said well contacting walls, wherein said second angle is about equal to said first angle;
said mat body fabric cover including
a mat body fabric cover top wall and a mat body fabric cover bottom wall composed of an anti-slip material, connected through at least three mat body fabric cover side walls and at least three mat body fabric cover well walls; a well floor pad connected to said at least three mat body fabric cover well walls; and a closeable opening for inserting the mat body into the mat body fabric cover;
at least one insert fabric cover attachment member attached to a wall or at the intersection of walls of the mat body fabric cover or attached along the outermost edge of the well floor pad of the mat body fabric cover; and at least one accessory attachment point disposed at or near the intersection of said mat body fabric cover side walls with said mat body fabric cover top wall; and
at least two handle forming members attached to the mat body fabric cover along two opposite side walls, or at the intersection of said mat body fabric cover bottom wall and said mat body fabric cover side walls, or at the intersection of said mat body fabric cover side walls and said mat body fabric cover top wall;
said insert fabric cover including
an insert fabric cover top wall and an insert fabric cover bottom wall connected through an insert fabric cover rear wall and at least three insert fabric cover well contacting walls;
a closeable opening for inserting said foam insert into the insert fabric cover; and
at least one mat body fabric cover attachment member adapted to removably engage said at least one insert fabric cover attachment member on said mat body fabric cover, wherein said mat body fabric cover attachment member is attached to a wall or at the intersection of walls of the insert fabric cover.
